(19) United States
(12) Patent Application Publication
(10) Pub. No.: US 2013/0238238 A1
(43) Pub. Date: Sep. 12, 2013

(54) BICYCLE FRAME OF CARBON FIBER AND BICYCLE INCLUDING THE SAME

(71) Applicant: AWISE FIBER TECHNOLOGY CO., LTD., Pingtung City (TW)

(72) Inventor: John HSUAN, Pingtung City (TW)

(73) Assignee: AWISE FIBER TECHNOLOGY CO., LTD., Pingtung City (TW)

(21) Appl. No.: 13/628,714

(22) Filed: Sep. 27, 2012

(30) Foreign Application Priority Data
Mar. 6, 2012 (TW) 101107462

(51) Int. Cl. B62K 19/40; G01S 5/02

(52) U.S. Cl. 701/468; 280/281.1; 280/263

(57) ABSTRACT

A bicycle frame of carbon fiber comprises a main frame and a lead. The main frame includes a plurality of carbon fiber tubes interconnected together. The lead is arranged in a tube wall of at least one of the carbon fiber tubes, and one end of the lead passes through the carbon fiber tube. Furthermore, a bicycle including the above-mentioned bicycle frame of carbon fiber is also disclosed. The above-mentioned bicycle frame of carbon fiber and the bicycle are easily integrated with electronic devices for providing functions of information and entertainment.

### BACKGROUND OF THE INVENTION

1. Field of the Invention

The present invention relates to a bicycle frame and bicycle, and more particularly to a bicycle frame of carbon fiber and a bicycle including the same.

2. Description of the Prior Art

A bicycle frame, which is made of carbon fiber composite materials, has advantages of light weight, high strength, etc.; therefore it has been widely applied to the field of industry. In recent years, a bicycle is not only a kind of vehicle for transportation but also a tool for exercise and leisure activities. By the trends of riding safety, sport leisure, and infortainment, many small-sized electronic products are developed, such as smart handheld device, power/cadence/speed sensor, trace recorder, multimedia player device, etc. A wireless electronic product has no limitation of exiting cable, but it is more expensive and consumes more power. Besides, the wireless electronic product only transmits wireless signals, and cannot transmit power, such as required power of lighting equipment. A wired electronic product needs to be considered the allocation of cables. An exposed cable on bicycle frame not only affects good appearance but also results in concerns about the safety. Accordingly, it highly desirable to integrate the bicycle frame of carbon fiber with related electronic products and simplify its operation.

### SUMMARY OF THE INVENTION

The present invention is directed to a bicycle frame of carbon fiber and a bicycle. A lead and even electronic devices are integrated within the bicycle frame of carbon fiber during manufacturing process of carbon fiber tube to avoid damaging the structure of the bicycle frame when installing electronic devices, which is different from the way the lead has to been installed on the bicycle during assembling process of the bicycle in the field.

In one embodiment of the present invention, the proposed bicycle frame of carbon fiber comprises a main frame and a lead. The main frame includes a plurality of carbon fiber tubes interconnected together. The lead is arranged in a tube wall of at least one of the carbon fiber tubes, and one end of the lead passes through the carbon fiber tube.

In another embodiment of the present invention, the proposed bicycle comprises a bicycle frame of carbon fiber, a front wheel, a rear wheel, a steering element, and a transmission element. The bicycle frame of carbon fiber comprises a main frame and a lead. The main frame includes a plurality of carbon fiber tube interconnected together. The lead is arranged in a tube wall of at least one of the carbon fiber tubes, and one end of the lead passes through the carbon fiber tube. The front wheel and the rear wheel are respectively arranged in front and rear of the bicycle frame of carbon fiber. The steering element is connected to the front wheel for controlling the moving direction of the front wheel. The transmission element is connected to the rear wheel for transmitting pedal force of a user to drive the rear wheel.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein:

FIG. 1 is a cross-sectional diagram schematically illustrating a bicycle frame of carbon fiber according to an embodiment of the present invention;

FIG. 2 is a cross-sectional diagram schematically illustrating a carbon fiber tube with a conduit according to an embodiment of the present invention;

FIG. 3 is a cross-sectional diagram schematically illustrating a bicycle frame of carbon fiber according to another embodiment of the present invention;

FIG. 4 is a block diagram schematically illustrating an electronic device integrated within a bicycle frame of carbon fiber according to an embodiment of the present invention; and

FIG. 5 is a diagram schematically illustrating a bicycle according to an embodiment of the present invention.

### DESCRIPTION OF THE PREFERRED EMBODIMENT

The detailed explanation of the present invention is described as follows. The described preferred embodiments are presented for purposes of illustrations and description, and they are not intended to limit the scope of the present invention.

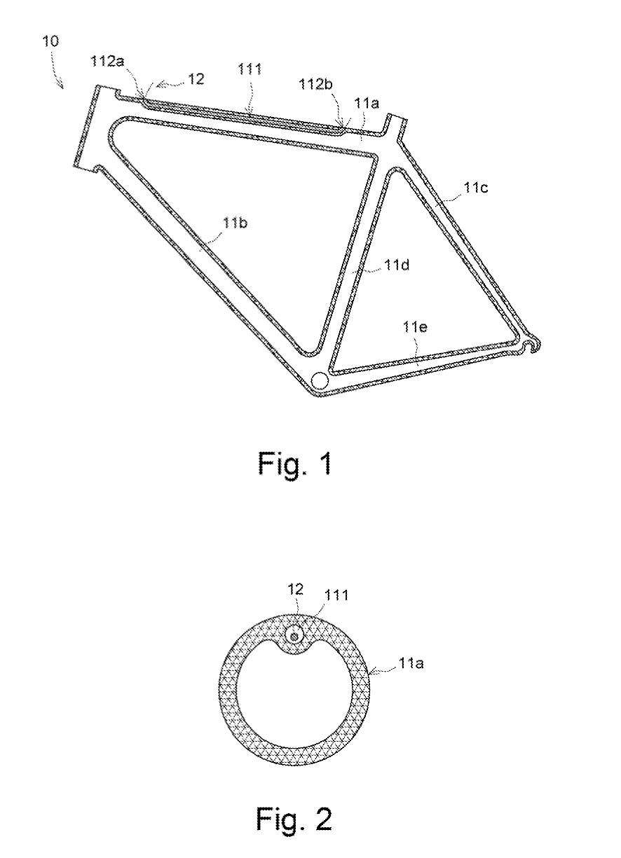

Referring to FIG. 1 and FIG. 2, a bicycle frame of carbon fiber according to an embodiment of the present invention comprises a main frame 10 and a lead 12. The main frame 10 includes a plurality of carbon fiber tubes 11a˜11e interconnected together. It should be noted that besides the structure of the bicycle frame shown in FIG. 1, the term “bicycle frame” also includes handle, front fork, seatpost, etc. under certain circumstance. The lead 12 is arranged in a tube wall of at least one of the carbon fiber tubes 11a˜11e, and one end of the lead 12 passes through one of the carbon fiber tubes 11a˜11e. For example, at least one of the carbon fiber tubes 11a˜11e has a conduit 111. In the embodiment of the present invention shown in FIG. 1 and FIG. 2, the conduit 111 is arranged in a tube wall of the carbon fiber tube 11a, and one end of the conduit 111 is connected to the exterior of the carbon fiber tube 11a to form a first opening 112a on the exterior surface of the carbon fiber tube 11a. But not limited to the embodiment, the conduit 111 can be arranged in the carbon fiber tubes 11b, 11c, 11d, or 11e according to need. The lead 12 is arranged in the conduit 111 and one end of the lead 12 passes through the carbon fiber tube 11a via the first opening 112a, so that the lead 12 can be arranged in a tube wall of the carbon fiber tube 11a˜11e.

In one embodiment, the other end of the conduit 111 can be also connected to the exterior of carbon fiber tube 11a and forms a second opening 112b on the exterior surface of carbon fiber tube 11a. The other end of the lead 12 may pass through carbon fiber tube 11a via the second opening 112b. The lead 12 can be used for transmitting power and/or a signal. For example, during the manufacturing process of the bicycle frame of carbon fiber, a core material can be arranged in predetermined position of the conduit 111. The core material is removed after hot forming of the bicycle frame or carbon fiber tube to form the conduit 111. But it is not limited to the embodiment, the lead 12 can be also bonded in a tube wall of the carbon fiber tube by lamination during manufacturing process, and the lead 12 is electrically independent from the carbon fiber tube. For example, the lead 12 wrapped by insulating material can be arranged between laminated layers of carbon fiber materials during manufacturing process of the carbon fiber tube, so that the lead is wrapped in a tube wall of the carbon fiber tube after the following hot-press process.

In one embodiment of the present invention, the position of the first opening 112a can be close to the handle end of the bicycle, and the second opening 112b can be close to the seat end of the bicycle. According to the structure of the bicycle, an electronic device (such as multimedia player device, navigation, driving recorder, communication device, touch panel, etc.) arranged in the handle end can be electrically connected to the electronic device (such as a battery module) arranged in the seat end of the bicycle frame via the lead 12 arranged in the conduit 111.

In one embodiment of the present invention, the bicycle frame of carbon fiber further comprises an antenna (not shown), which is arranged in one of the carbon fiber tubes 11a˜11e (e.g., interior surface or a tube wall of the carbon fiber tubes 11a˜11e). The antenna is electrically connected to the carbon fiber tube; the antenna can be electrically connected to an external electronic device via the lead 12. For example, the antenna in the carbon fiber tube can be close to the handle end of the bicycle, and electrically connected to a smart handheld device via the lead 12 which passes through the carbon fiber tube. According to the structure of the bicycle, the carbon fiber tube can be an antenna extension of the smart handheld device for improving speech quality, connecting social network, or receiving GPS satellite signal.

In one embodiment of the present invention, the bicycle frame of carbon fiber further comprises a connection port (not shown) which is electrically connected to the lead 12 and arranged at the side of first opening 112a or at the side of the second opening 112b. The connection port has at least one conductive contact so that an external electronic device can be electrically connected to the lead 12 easily.

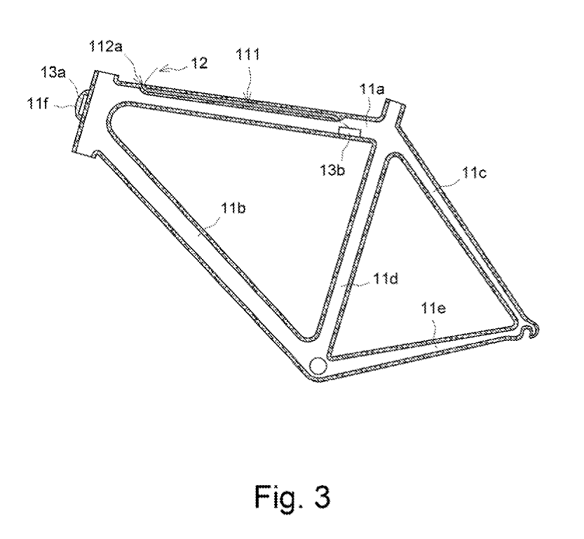

Referring to FIG. 3, in one embodiment of the present invention, the bicycle frame of carbon fiber further comprises a radio frequency identification tag (RFID tag)13a. The RFID tag 13a can be covered with a glass fiber material 11f and the RFID tag 13a is attached to the exterior surface of one of the carbon fiber tubes 11a˜11e to avoid affecting communication quality of RFID tag 13a due to carbon fiber materials of the carbon fiber tubes 11a˜11e. The RFID tag 13a may store the owner information of the bicycle, manufacturing record, sales history or simple maintenance records. Alternately, the RFID tag 13a may store specific location stamps to prove the bicycle has been to those specific locations. The owner of the bicycle and related records can be known by reading information stored in the RFID tag 13a by a RFID reader. Therefore, bicycles obtained through irregular channels are not easily sold to any third person, thereby achieving the effect of deterring thieves from disposing of stolen bicycles. In addition, because the RFID tag 13a is covered with the glass fiber material 11f and attached to the carbon fiber tubes 11a˜11e. Once the glass fiber material 11f on the outer layer of the RFID tag 13a has been damaged, it will be also damage the bicycle frame or degrade its strength of structure so as to prevent thieves from taking the RFID tag 13a.

In one embodiment of the present invention, the bicycle frame of carbon fiber comprises an electronic device 13b which is arranged in the inner side of at least one of the carbon fiber tubes 11a˜11e and electrically connected to the other end of the lead 12. Hence, the electronic device 13b arranged in the carbon fiber tubes 11a can be electrically connected to the outside via the lead 12. For example, the electronic device 13b can be electrically connected to the external electronic device for exchanging information. Alternately, the electronic device 13b can be electrically connected to the external power supply for charging or supplying electrical power in operation.

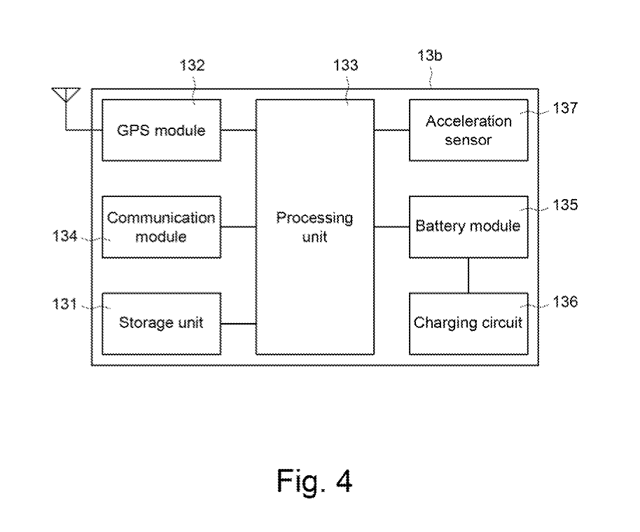

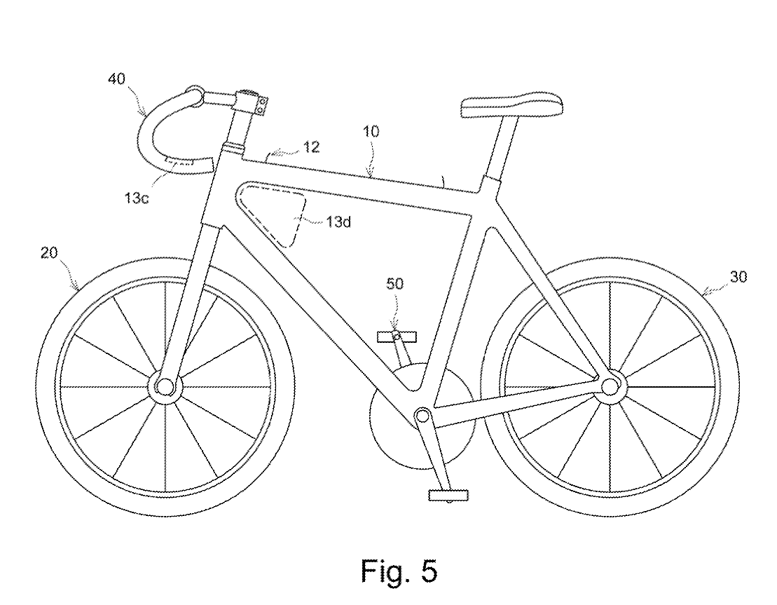

Referring to FIG. 4, for example, the electronic device 13b can be a trace recorder which comprises a storage unit 131, global positioning system (GPS) module 132, and a processing unit 133. The GPS module 132 is used for generating a location coordinate. The processing unit 133 is electrically connected to the GPS module 132 and the storage unit 131. The processing unit 133 is used for storing the location coordinate generated by the GPS module 132 and a corresponding time stamp in the storage unit 131 to record the route of the bicycle.

In a preferred embodiment of the present invention, the electronic device 13b further comprises a communication module 134 and an acceleration sensor 137, which are electrically connected to the processing unit 133 respectively. The communication module 134 can transmit the location coordinate generated by the GPS module 132 to a remote electronic device. For example, the communication module 134 may be a wireless local area network (WLAN) module or a mobile communication module (such as GSM, GPRS, CDMA, WCDMA, WIMAX, LTE, etc.). According to the above-mentioned architecture, when the bicycle is touched by a thief, the acceleration sensor 137 can detect abnormal vibration or movement, the process unit 133 can send a message or dial the assigned number via the communication module 134 to inform the user at the same time. Besides, the user can find the current location of the stolen bicycle, i.e. the location coordinate generated by the GPS module 132, thereby helping the owner of the bicycle recover the bicycle. It can be understood that the antenna can be built-in with the electronic device 13b, or the above-mentioned antenna arranged in a tube wall of the carbon fiber tube can be also served as the antenna of the electronic device 13b.

In one embodiment of the present invention, the electronic device 13b can acquire the external power supply (such as mobile battery) via the lead 12 for providing electrical power in operation. Therefore, a battery module is not additionally arranged in the electronic device 13b, but it is not limited to the embodiment, the electronic device 13b also comprises the battery module 135 for supplying electrical power to the electronic device 13b in operation. In a preferred embodiment of the present invention, the electronic device 13b further comprises a charging circuit 136 which is electrically connected to the battery module 135. As described above, the charging circuit 136 can be electrically connected to the external power supply via the lead 12. Therefore, when the electronic device 13b is electrically connected to the external power supply via the lead 12, the charging circuit 136 can charge the battery module 135. According to the above-mentioned architecture, even the electronic device 13b is not electrically connected to the external power supply, the electronic device 13b still can provide information about the related location or the route of the bicycle before electrical power of the battery module 135 is exhausted.

Referring FIG. 5, a bicycle according to one embodiment of the present invention comprises a bicycle frame of carbon fiber 10, a front wheel 20, a rear wheel 30, a steering element 40, and a transmission unit 50. The detailed structure of the bicycle frame of carbon fiber 10 has been described above, not repeat it again here. The front wheel 20 and the rear wheel 30 are respectively arranged in front and rear side of the bicycle frame of carbon fiber 10. The steering element 40 is connected to the front wheel 20 for controlling the moving direction of the front wheel 20. For example, the steering element 40 comprises bicycle elements of prior art, such as a handle, a front fork, etc. The transmission unit 50 is connected to the rear wheel 30 for transmitting pedal force of a user to drive the rear wheel. For example, the transmission unit 50 comprises bicycle elements of prior art, such as a crank, a pair of left and right foot pedals, gears, a chain, etc., so that the rear wheel 30 is driven to rotate by the pedal force of the user for driving the bicycle moving forward.

In one embodiment of the present invention, the bicycle comprises a sensor for sensing a user's electrocardiogram and/or heart rate signal. For example, the sensor includes two sensing contacts 13c which are respectively arranged in holding positions at two ends of the handle of the steering element 40. According to the structure of the bicycle, the user holds two ends of the handle when riding a bicycle, the user's exercise electrocardiogram and heart rate signal can be detected by touching the sensing contacts 13c arranged in the handle via the user' finger or hand. Alternatively, the sensing contact can be respectively arranged in the seat of the bicycle. According to the structure of the bicycle, two sides of the user' hip respectively contact with two sensing contact arranged in two side of the seat when riding a bicycle, the user's exercise electrocardiogram and heart rate signal can be also detected.

When an anomaly occurs in the user's exercise electrocardiogram or heart rate index, a monitoring system equipped with the bicycle or a remote monitoring system can send a warning signal to remind the user to slow down or take a break. Beside, the electrocardiogram/heart rate sensing system can also detect user's mental fatigue level for monitoring user's mental fatigue status. For example, mental fatigue of the user when riding is detected by the electrocardiogram/heart rate sensing system, a warning signal is sent to remind the user to take a break or it's not suitable for riding continuously. As mentioned above, the sensing contact 13c can be also electrically connected to the sensor via the lead 12 arranged in the carbon fiber tube. In one embodiment, the electrocardiogram and/or heart rate signal sensed by the sensor can be used for identifying the user, which can be achieved by capturing and comparing characteristics of the electrocardiogram and/or heart rate signal.

In one embodiment of the present invention, the bicycle comprises a mobile battery module 13d which is arranged in outer side of carbon fiber tube (e.g., suspended to outer side of the main frame 10). The mobile battery module 13d is electrically connected to the lead 12 so that mobile battery module 13d can supply electrical power to an electronic device such as multimedia player, handheld device, sensor, built-in touch panel or buttons on surface of the handle, etc. The built-in touch panel or buttons on surface of the handle can be served as an interface of various electrical functions for quick operation.

In conclusion, in the bicycle frame of carbon fiber and the bicycle of the present invention, the lead is integrated into the bicycle frame of carbon fiber during manufacturing process; therefore there is no need of drilling holes on the bicycle frame so as to avoid damaging the structure of the bicycle when installing electronic devices. In addition, the opening of the conduit of the main frame can be sealed by a sealing element in advance; then make the conduit open when the lead needs to be installed in the conduit, therefore it can avoid the lead is hard to be installed because of accumulated dust in the conduit of the carbon fiber tube. Besides, it can integrate electronic devices, such as the RFID tag, the GPS module, etc., within the bicycle frame of carbon fiber, thereby achieving the effect of deterring thieves and decreasing the rate of bike theft. The user's of physiology status, riding, surrounding environment can be real-time monitored by various kind of sensors (such as electrocardiogram and/or heart rate sensor, power/cadence/speed sensor, temperature/humidity/air quality/ultraviolet/san dust/ozone/probability of precipitation sensor).

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A bicycle frame of carbon fiber, comprising:
a main frame, including a plurality of carbon fiber tubes interconnected together; and
a lead arranged in a tube wall of at least one of the carbon fiber tubes, wherein one end of the lead passes through the carbon fiber tube.

2. The bicycle frame of carbon fiber according to claim 1, wherein the lead is bonded in the tube wall of the carbon fiber tube by lamination process, and the lead is electrically independent from the carbon fiber tube.

3. The bicycle frame of carbon fiber according to claim 1, wherein the main frame has a conduit arranged in the tube wall of at least one of the carbon fiber tubes, one end of the conduit is connected to the exterior of the carbon fiber tube and forms a first opening; the lead is arranged in the conduit and passes through the carbon fiber tube via the first opening.

4. The bicycle frame of carbon fiber according to claim 3, wherein the other end of the conduit is connected to the exterior of the carbon fiber tube and forms a second opening, and the other end of the lead passes through the carbon fiber tube via the second opening.

5. The bicycle frame of carbon fiber according to claim 1, further comprising:
an antenna arranged in one of the carbon fiber tubes, and electrically connected to the carbon fiber tube, the antenna is electrically connected to an external electronic device via the lead.

6. The bicycle frame of carbon fiber according to claim 1, further comprising:
a connection port electrically connected to the lead, arranged at an exposed end of the lead, and having at least one conductive contact.

7. The bicycle frame of carbon fiber according to claim 1, further comprising:
a radio frequency identification tag (RFID tag), which is covered with a glass fiber material and attached to the exterior surface of one of the carbon fiber tubes.

8. The bicycle frame of carbon fiber according to claim 1, further comprising:
a steering element connected to the main frame, for controlling moving direction of a carbon fiber bicycle, wherein the steering element comprises:
a handle; and
a sensor including two sensing contacts, the two sensing contacts are respectively arranged in holding positions at two ends of the handle, for sensing a user's electrocardiogram and/or heart rate signal.

9. The bicycle frame of carbon fiber according to claim 1, further comprising:
a seat connected to the main frame; and
a sensor, including two sensing contacts, the two sensing contacts are respectively arranged on the surface of the seat, which contact two sides of a user's hip, for sensing the user's electrocardiogram and/or heart rate signal.

10. The bicycle frame of carbon fiber according to claim 1, further comprising:
an electronic device arranged in one of the plurality of carbon fiber tubes, and electrically connected to the other end of the lead, so that the electronic device is electrically connected to an external electronic device or an external power supply via the lead.

11. The bicycle frame of carbon fiber according to claim 10, wherein the electronic device comprises a trace recorder, the trace recorder comprising:
a storage unit;
a global positioning system (GPS) module, for generating a location coordinate; and
a processing unit electrically connected to the GPS module and the storage unit, for storing the location coordinate and a corresponding time stamp in the storage unit.

12. The bicycle frame of carbon fiber according to claim 11, wherein the trace recorder further comprises a communication module electrically connected to the processing unit, for transmitting the location coordinate to a remote electronic device.

13. The bicycle frame of carbon fiber according to claim 12, wherein the trace recorder further comprises an acceleration sensor electrically connected to the processing unit, for detecting abnormal vibration and movement of the bicycle frame of carbon fiber.

14. The bicycle frame of carbon fiber according to claim 11, wherein the trace recorder further comprises a battery module, for supplying electrical power to the trace recorder in operation.

15. The bicycle frame of carbon fiber according to claim 14, wherein the trace recorder further comprises a charging circuit electrically connected to the battery module, and the charging circuit is electrically connected to the external power supply via the lead for charging the battery module.

16. The bicycle frame of carbon fiber according to claim 1, further comprising:
a mobile battery module arranged in outer side of the bicycle frame of carbon fiber, and electrically connected to the lead, for supplying electrical power to an external electronic device via the lead.

17. A bicycle, comprising:
a bicycle frame of carbon fiber which comprises:
a main frame, including a plurality of carbon fiber tubes interconnected together; and
a lead arranged in a tube wall of at least one of the carbon fiber tubes, wherein one end of the lead passes through the carbon fiber tube;
a front wheel arranged in front of the bicycle frame of carbon fiber;
a rear wheel arranged in rear of the bicycle frame of carbon fiber;
a steering element connected to the front wheel, for controlling the moving direction of the front wheel; and
a transmission element connected to the rear wheel, for transmitting pedal force of a user to drive the rear wheel.

18. The bicycle according to claim 17, wherein the lead is bonded in the tube wall of the carbon fiber tube by lamination process, and the lead is electrically independent from the carbon fiber tube.

19. The bicycle according to claim 17, wherein the main frame has a conduit arranged in the tube wall of at least one of the carbon fiber tubes, one end of the conduit is connected to the exterior of the carbon fiber tube and forms a first opening; the lead is arranged in the conduit and passes through the carbon fiber tube via the first opening.

20. The bicycle according to claim 19, wherein the other end of the conduit is connected to the exterior of the carbon fiber tube and forms a second opening, and the other end of the lead passes through the carbon fiber tube via the second opening.

21. The bicycle according to claim 17, wherein the bicycle frame of carbon fiber further comprises:
an antenna arranged in one of the carbon fiber tubes, and electrically connected to the carbon fiber tube, the antenna is electrically connected to an external electronic device via the lead.

22. The bicycle according to claim 17, wherein the bicycle frame of carbon fiber further comprises:
a connection port electrically connected to the lead, arranged at an exposed end of the lead, and having at least one conductive contact.

23. The bicycle according to claim 17, wherein the bicycle frame of carbon fiber further comprises:
a radio frequency identification tag (RFID tag), which is covered with a glass fiber material and attached to exterior surface of one of the carbon fiber tubes.

24. The bicycle according to claim 17, further comprising:
a sensor including two sensing contacts, the two sensing contacts are respectively arranged in holding positions at two ends of a handle of the steering element or arranged on surface of a seat contacting with two sides of a user' hip, for sensing the user's electrocardiogram and/or heart rate signal.

25. The bicycle according to claim 17, wherein the bicycle frame of carbon fiber further comprises an electronic device arranged in one of the plurality of carbon fiber tubes, and electrically connected to the other end of the lead, so that the electronic device is electrically connected to an external electronic device or an external power supply via the lead.

26. The bicycle according to claim 25, wherein the electronic device comprises a trace recorder, the trace recorder comprising:
a storage unit;
a global positioning system (GPS) module, for generating a location coordinate; and
a processing unit electrically connected to the GPS module and the storage unit, for storing the location coordinate and a corresponding time stamp in the storage unit.

27. The bicycle according to claim 26, wherein the trace recorder further comprises a communication module electrically connected to the processing unit, for transmitting the location coordinate to a remote electronic device.

28. The bicycle according to claim 27, wherein the trace recorder further comprises an acceleration sensor electrically connected to the processing unit, for detecting abnormal vibration and movement of the bicycle frame of carbon fiber.

29. The bicycle according to claim 26, wherein the trace recorder further comprises a battery module, for supplying electrical power to the trace recorder in operation.

30. The bicycle according to claim 29, wherein the trace recorder further comprises a charging circuit electrically connected to the battery module, and the charging circuit is electrically connected to the external power supply via the lead for charging the battery module.

31. The bicycle according to claim 17, further comprising:
a mobile battery module arranged in outer side of the bicycle frame of carbon fiber, and electrically connected to the lead, for supplying electrical power to an external electronic device via the lead.

32. The bicycle according to claim 17, further comprising:
a touch panel or buttons arranged on a surface of a handle of the steering element and served as a user interface to control an outer electronic device.
